(19) United States
(12) Patent Application Publication
(10) Pub. No.: US 2022/0187568 A1
(43) Pub. Date: Jun. 16, 2022

(54) LENS SYSTEM, PHOTOGRAPHING APPARATUS, AND MOVABLE OBJECT

(71) Applicant: SZ DJI TECHNOLOGY CO., LTD., Shenzhen (CN)

(72) Inventors: Hajime INUKAI, Shenzhen (CN); Atsushi OHATA, Shenzhen (CN); Shigehiko MATSUNAGA, Shenzhen (CN); Tatsuya NAKATSUJI, Shenzhen (CN)

(73) Assignee: SZ DJI TECHNOLOGY CO., LTD., Shenzhen (CN)

(21) Appl. No.: 17/546,035

(22) Filed: Dec. 8, 2021

Related U.S. Application Data
(63) Continuation of application No. PCT/CN2020/107814, filed on Aug. 7, 2020.

(30) Foreign Application Priority Data
Aug. 20, 2019 (JP) 2019-150354

(51) Int. Cl. G02B 9/12; G02B 13/00; G03B 15/00; B64C 39/02; B64D 47/08

(52) U.S. Cl. CPC G02B 9/12; G02B 13/006; G03B 15/006; B64C 2201/127; B64D 47/08; B64C 2201/027; B64C 39/024

(57) ABSTRACT

A lens system includes sequentially from an object side: a first lens group having a positive refractive power; an aperture diaphragm; a second lens group having a positive refractive power; and a third lens group having a positive refractive power and moving along a direction of an optical axis when focusing from an object at infinity to a close object. Assuming that L is a distance from a lens surface of the first lens group closest to the object side to a lens surface closest to an image side on the optical axis, Y is a maximum image height, f1 is a focal length of the first lens group, and f is a focal length of the entire lens system, the lens system satisfies the following conditions: 1.0<L/Y<2.3, and 1<f1/f<3.

### RELATED APPLICATIONS

This application is a continuation application of PCT application No. PCT/CN2020/107814, filed on Aug. 7, 2020, which claims the priority of Japanese patent application No. JP 2019-150354, filed on Aug. 20, 2019, and the contents of which are incorporated herein by reference in their entireties.

### TECHNICAL FIELD

The present disclosure relates to a lens system, a photographing apparatus, and a movable object.

### BACKGROUND

Due to the need to ensure a sufficiently long back focal length, a retrofocus-type lens system is widely used. The retrofocus-type lens system generally has a relatively long back focal length, includes, starting from an object side, a negative lens group, a diaphragm, and a positive lens group in sequence, and has a structure asymmetric about the diaphragm. For example, existing negative lens systems are disclosed in a patent document 1, a patent document 2, and a patent document 3.

Patent document 1: JP2012173435 (A)

Patent document 2: JP2011209377 (A)

Patent document 3: JP2014199462 (A)

### SUMMARY

A miniature wide-angle lens having a well-corrected magnification chromatic aberration is expected.

In a first aspect of the present disclosure, a lens system is provided, including, sequentially from an object side: a first lens group having a positive refractive power, including: a negative meniscus lens that is arranged closest to the object side and includes a convex surface facing the object side, and a first cemented lens; an aperture diaphragm next to the first cemented lens; a second lens group having a positive refractive power, including a second cemented lens arranged next to the aperture diaphragm; and a third lens group that has a positive refractive power and is movable along a direction of an optical axis as focusing from an object at infinity distance to a closer object, including a single lens, where the following conditions are satisfied: 1.0<L/Y<2.3, and 1<f1/f<3, where L is a distance from a lens surface of the first lens group closest to the object side to a lens surface closest to an image side on the optical axis, Y is a maximum image height, f1 is a focal length of the first lens group, and f is a focal length of the entire lens system.

In a second aspect of the present disclosure, a photographing apparatus is provided, including a photographing element; and a lens system, including, sequentially from an object side: a first lens group having a positive refractive power, including: a negative meniscus lens that is arranged closest to the object side and includes a convex surface facing the object side, and a first cemented lens; an aperture diaphragm next to the first cemented lens; a second lens group having a positive refractive power, including a second cemented lens arranged next to the aperture diaphragm; and a third lens group that has a positive refractive power and is movable along a direction of an optical axis as focusing from an object at infinity distance to a closer object, including a single lens, where the following conditions are satisfied: 1.0<L/Y<2.3, and 1<f1/f<3, where L is a distance from a lens surface of the first lens group closest to the object side to a lens surface closest to an image side on the optical axis, Y is a maximum image height, f1 is a focal length of the first lens group, and f is a focal length of the entire lens system.

In a third aspect of the present disclosure, a movable object is provided, including: a lens system, including, sequentially from an object side: a first lens group having a positive refractive power, including: a negative meniscus lens that is arranged closest to the object side and includes a convex surface facing the object side, and a first cemented lens; an aperture diaphragm next to the first cemented lens; a second lens group having a positive refractive power, including a second cemented lens arranged next to the aperture diaphragm; and a third lens group that has a positive refractive power and is movable along a direction of an optical axis as focusing from an object at infinity distance to a closer object, including a single lens, where the following conditions are satisfied: 1.0<L/Y<2.3, and 1<f1/f<3, where L is a distance from a lens surface of the first lens group closest to the object side to a lens surface closest to an image side on the optical axis, Y is a maximum image height, f1 is a focal length of the first lens group, and f is a focal length of the entire lens system.

A lens system according to an aspect of the present disclosure may sequentially include from an object side: a first lens group, having a positive refractive power; an aperture diaphragm; a second lens group, having a positive refractive power; and a third lens group, having a positive refractive power, and moving along a direction of an optical axis when focusing from an object at infinity to a close object. The first lens group may include: a negative meniscus lens, which is arranged closest to the object side and whose convex surface faces the object side, and a first cemented lens, which is arranged closest to the aperture diaphragm. The second lens group may include a second cemented lens arranged closest to the aperture diaphragm. The third lens group may include a single lens. Assuming that L is a distance from a lens surface of the first lens group closest to the object side to a lens surface closest to an image side on the optical axis, and Y is a maximum image height, and f1 is a focal length of the first lens group, and f is a focal length of the entire lens system, the following conditions may be satisfied:

1.0<L/Y<2.3, and

1<f1/f<3.

Assuming that fL11 is a focal length of the negative meniscus lens, and fCL1 is a focal length of the first cemented lens, the following conditions may be satisfied:

−2.0<fL11/f<0.5, and

0.4<fCL1/f1<2.5.

Assuming that NCL1p is a refractive index of a positive lens constituting the first cemented lens to a d-line, and NCL1n is a refractive index of a negative lens constituting the first cemented lens to the d-line, and VCL1p is an Abbe number of the positive lens constituting the first cemented lens based on the d-line, and VCL1n is an Abbe number of the negative lens constituting the first cemented lens based on the d-line, and θCL1p is a partial dispersion ratio of the positive lens constituting the first cemented lens between a g-line and an F-line, and θCL1n is a partial dispersion ratio of the negative lens constituting the first cemented lens between the g-line and the F-line, the following conditions may be satisfied:

0<NCL1p−NCL1n<0.3,

3<VCL1p−VCL1n<20, and

−0.07<θCL1p−θCL1n<−0.02.

Assuming that NCL2p is a refractive index of a positive lens constituting the second cemented lens to a d-line, and NCL2n is a refractive index of a negative lens constituting the second cemented lens to the d-line, and θCL2p is a partial dispersion ratio of the positive lens constituting the second cemented lens between a g-line and an F-line, and θCL2n is a partial dispersion ratio of the negative lens constituting the second cemented lens between the g-line and the F-line, the following conditions may be satisfied:

−0.3<NCL2p−NCL2n<0, and

−0.08<θCL2p−θCL2n<0.04.

Assuming that VL11 is an Abbe number of the negative meniscus lens based on a d-line, and θgL11 is a partial dispersion ratio of the negative meniscus lens between a g-line and an F-line, the following conditions may be satisfied:

VL11>55, and

0.62<θgL11+0.001625×VL11<0.70.

Assuming that f3 is a focal length of the third lens group, the following condition may be satisfied:

2.0<f3/f<5.5.

All lenses may be spherical lenses.

Assuming that ω is a maximum half field angle of the lens system, the following condition may be satisfied:

−0.25<(Y−f·tan ω)/(f·tan ω)<−0.05.

A photographing apparatus according to an aspect of the present disclosure includes the foregoing lens system. The photographing apparatus includes a photographing element.

A movable object according to an aspect of the present disclosure includes the foregoing lens system and is capable of moving.

The movable object may be an unmanned aerial vehicle.

According to the foregoing lens system, a miniature lens system having a well-corrected magnification chromatic aberration can be provided.

The summary does not list all features of the present disclosure. Sub-combinations of these feature groups may constitute the present disclosure.

### BRIEF DESCRIPTION OF THE DRAWINGS

FIG. 1 shows a lens configuration, optical members PP1 and PP2, and an image plane IM of a lens system 100 according to some exemplary embodiments;

FIG. 2 shows a spherical aberration, astigmatism, a distortion aberration, and a magnification chromatic aberration of the lens system 100 in an infinite focus state;

FIG. 3 shows a lens configuration, optical members PP1 and PP2, and an image plane IM of a lens system 200 according to some exemplary embodiments;

FIG. 4 shows a spherical aberration, astigmatism, a distortion aberration, and a magnification chromatic aberration of the lens system 200 in an infinite focus state;

FIG. 5 shows a lens configuration, optical members PP1 and PP2, and an image plane IM of a lens system 300 according to some exemplary embodiments;

FIG. 6 shows a spherical aberration, astigmatism, a distortion aberration, and a magnification chromatic aberration of the lens system 300 in an infinite focus state;

FIG. 7 shows a lens configuration, optical members PP1 and PP2, and an image plane IM of a lens system 400 according to some exemplary embodiments;

FIG. 8 shows a spherical aberration, astigmatism, a distortion aberration, and a magnification chromatic aberration of the lens system 400 in an infinite focus state;

FIG. 9 shows a lens configuration, optical members PP1 and PP2, and an image plane IM of a lens system 500 according to some exemplary embodiments;

FIG. 10 shows a spherical aberration, astigmatism, a distortion aberration, and a magnification chromatic aberration of the lens system 500 in an infinite focus state;

FIG. 11 schematically shows an example of a movable object system 10 including an unmanned aerial vehicle (UAV) 40 and a controller 50;

FIG. 12 shows an example of functional blocks of the UAV 40; and

FIG. 13 is an exterior perspective view of an example of a stabilizer 3000.

### DETAILED DESCRIPTION

The following describes the present disclosure with reference to some exemplary embodiments. However, the exemplary embodiments do not limit the claims. In addition, all feature combinations described in the exemplary embodiments are not necessarily mandatory for solutions of the present disclosure. For a person of ordinary skill in the art, obviously various modifications or improvements may be made to the exemplary embodiments. Obviously, from the descriptions of the claims, any manner of such variations or improvements should be included in the technical scope of the present disclosure.

The claims, the specification, the accompanying drawings, and the abstract contain materials which may be subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

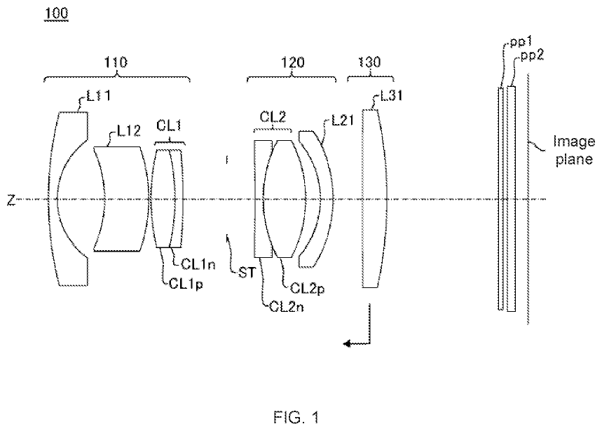

Some exemplary embodiments of lens systems are disclosed with reference to FIG. 1 to FIG. 10. As shown in some exemplary embodiments, a lens system may sequentially include, starting from an object side: a first lens group having a positive refractive power; an aperture diaphragm; a second lens group having a positive refractive power; and a third lens group having a positive refractive power which moves along a direction of an optical axis when focusing from an object at infinity to a close object. The first lens group includes: a negative meniscus lens, which is arranged closest to the object side and with a convex surface thereof facing the object side, and a first cemented lens, which is arranged closest to the aperture diaphragm. The second lens group includes a second cemented lens arranged closest to the aperture diaphragm. The third lens group includes a single lens. Assuming that L is a distance from a lens surface of the first lens group closest to the object side to a lens surface closest to an image side on the optical axis, a Y is a maximum image height, f1 is a focal length of the first lens group, and f is a focal length of the entire lens system, the following conditions may be satisfied:

1.0<L/Y<2.3 (1)

1<f1/f<3 (2)

Based on the foregoing structure, a high-resolution miniature optical system having a well-corrected magnification chromatic aberration may be implemented at a low price. The condition (1) is a condition about the distance from the lens surface of the first lens group closest to the object side to the lens surface closest to the image side on the optical axis and the maximum image height. Avoiding being below a lower limit of the condition (1) is advantageous for correcting a spherical aberration and an image plane curvature. Avoiding being above an upper limit of the condition (1) facilitates miniaturization.

The condition (2) is a condition about a relationship between the focal length of the entire lens system and the focal length of the first lens group. Avoiding being below a lower limit of the condition (2) is advantageous for correcting a spherical aberration and a chromatic aberration. Avoiding being above an upper limit of the condition (2) facilitates miniaturization. In addition, reducing the positive refractive power of the second lens group and suppressing a negative-side curvature of a Petzval image plane are advantageous for correcting an image plane curvature and astigmatism.

Since the negative meniscus lens that is arranged closest to the object side and whose convex surface faces the object side is used as a lens closest to the object side, it is easy to achieve a wide angle, and this is also advantageous for correcting a spherical aberration and astigmatism that tends to occur during widening of an angle of view.

The first cemented lens may include a positive lens having a positive refractive power and a negative lens having a negative refractive power. This is advantageous for correcting a chromatic aberration, and can suppress a high-order spherical aberration while suppressing an optical performance degradation caused by a manufacturing error such as eccentricity. If the positive lens included in the first cemented lens is made into a biconvex shape, a spherical aberration can be better corrected.

The second cemented lens may include a positive lens having a positive refractive power and a negative lens having a negative refractive power. This is advantageous for correcting a chromatic aberration, and can suppress a high-order spherical aberration while suppressing an optical performance degradation caused by a manufacturing error such as eccentricity. If the positive lens included in the second cemented lens is made into a biconvex shape, a spherical aberration can be better corrected.

The third lens group includes a single lens. This may reduce a weight of the focusing lens group, and is advantageous for ensuring a high speed and silence of a focusing action and accuracy of continuous focusing during video shooting or the like. Setting only one lens group to move during focusing can simplify a frame structure, and is advantageous for weight reduction, miniaturization, and cost reduction.

Satisfaction of the following condition (1-1) can make the foregoing effect more remarkable.

1.1<L/IH<1.7 (1-1)

In addition, satisfaction of the following condition (2-1) can make the foregoing effect more remarkable.

1.1<f1/f<2.2 (2-1)

Assuming that fL11 is a focal length of the negative meniscus lens, and fCL1 is a focal length of the first cemented lens, the lens system satisfies the following conditions:

−2.0<fL11/f<−0.5 (3)

0.4<fCL1/f1<2.5 (4)

The condition (3) is a condition about a relationship between the focal length of the negative meniscus lens and the focal length of the entire lens system. Avoiding being below a lower limit of the condition (3) may sufficiently ensure a negative refractive power of the negative meniscus lens, and is advantageous for ensuring a wide angle of view. In addition, reducing a forward enhancement trend of a Petzval image plane is advantageous for reduction of astigmatism. Avoiding being above an upper limit of the condition (3) can limit the refractive power of the negative lens, easily shorten a back focal length, and help shorten a total length of the optical system.

The condition (4) is a condition about a relationship between the focal length of the first lens group and the focal length of the first cemented lens. Avoiding being below a lower limit of the condition (4) facilitates miniaturization. By avoiding being above an upper limit of the condition (4), a negative focal power of the negative meniscus lens can be appropriately set, and a magnification chromatic aberration and a comatic aberration can be easily corrected.

Satisfaction of the following condition (3-1) can make the foregoing effect more remarkable.

−1.8<fL11/f<−0.8 (3-1)

In addition, satisfaction of the following condition (4-1) can make the foregoing effect more remarkable.

1.1<fCL1/f1<2.2 (4-1)

Assuming that NCL1p is a refractive index of the positive lens constituting the first cemented lens to a d-line, NCL1n is a refractive index of the negative lens constituting the first cemented lens to the d-line, VCL1p is an Abbe number of the positive lens constituting the first cemented lens based on the d-line, VCL1n is an Abbe number of the negative lens constituting the first cemented lens based on the d-line, θCL1p is a partial dispersion ratio of the positive lens constituting the first cemented lens between a g-line and an F-line, and θCL1n is a partial dispersion ratio of the negative lens constituting the first cemented lens between the g-line and the F-line, the lens system satisfies the following conditions:

0<NCL1p−NCL1n<0.3 (5)

3<VCL1p−VCL1n<20 (6)

−0.07<θCL1p−θCL1n<−0.02 (7)

Herein, the Abbe number is an approximate measure of a material's light dispersion. The Abbe number is defined based on Fraunhofer lines, which include a d-line (587.56 nm), a F-line (486.1 nm), a C line (656.3 nm), a g-line (435.8 nm), a h-line (404.7 nm), and the like.

The condition (5) is a condition about a difference between a refractive index of a material of the positive lens constituting the first cemented lens and a refractive index of a material of the negative lens having the negative refractive power. Avoiding being below a lower limit of the condition (5) is advantageous for correcting a spherical aberration. Avoiding being above an upper limit of the condition (5) may make a Petzval sum close to 0, and may suppress generation of an image plane curvature.

The condition (6) is a condition about a difference between the Abbe number of the positive lens and the Abbe number of the negative lens constituting the first cemented lens. By satisfying the condition (6), an axial chromatic aberration and a magnification chromatic aberration may be well corrected at the same time. By avoiding being below a lower limit of the condition (6), an axial chromatic aberration and a magnification chromatic aberration may be well corrected. Therefore, an optical system with good imaging performance may be obtained by using a small quantity of lens elements. Avoiding being above an upper limit of the condition (6) prevents excessive corrections of an axial chromatic aberration and a magnification chromatic aberration. Therefore, the quantity of lens elements required for correcting an aberration is reduced, and miniaturization is easily achieved while good imaging performance is maintained.

The condition (7) is a condition about a difference between a partial dispersion ratio of the material of the positive lens constituting the first cemented lens and a partial dispersion ratio of the material of the negative lens having the negative refractive power between the g-line and the F-line. Satisfaction of the condition (7) may suppress the generation of a secondary chromatic aberration.

Assuming that NCL2p is a refractive index of the positive lens constituting the second cemented lens to a d-line, NCL2n is a refractive index of the negative lens constituting the second cemented lens to the d-line, θCL2p is a partial dispersion ratio of the positive lens constituting the second cemented lens between a g-line and an F-line, and θCL2n is a partial dispersion ratio of the negative lens constituting the second cemented lens between the g-line and the F-line, the lens system satisfies the following conditions:

−0.3<NCL2p−NCL2n<0 (8)

−0.08<θCL2p−θCL2n<0.04 (9)

The condition (8) is a condition about a difference between a refractive index of a material of the positive lens constituting the second cemented lens and a refractive index of a material of the negative lens having the negative refractive power. Avoiding being below a lower limit of the condition (8) is advantageous for correcting a spherical aberration. Avoiding being above an upper limit of the condition (8) may make a Petzval sum close to 0, and may suppress the generation of an image plane curvature.

The condition (9) specifies a difference between a partial dispersion ratio of the material of the positive lens constituting the second cemented lens and a partial dispersion ratio of the material of the negative lens having the negative refractive power between the g-line and the F-line. Satisfaction of the condition (9) may suppress the generation of a secondary chromatic aberration.

Assuming that VL11 is an Abbe number of the negative meniscus lens based on a d-line, and θgL11 is a partial dispersion ratio of the negative meniscus lens between a g-line and an F-line, the lens system satisfies the following conditions:

VL11>55 (10)

0.62<θgL11+0.001625×VL11<0.70 (11)

The condition (10) is a condition about the Abbe number of the negative meniscus lens based on the d-line. Satisfaction of the condition (10) may suppress the generation of a magnification chromatic aberration. The condition (11) is a condition about the partial dispersion ratio of the negative meniscus lens between the g-line and the F-line. Selecting a material by avoiding being below a lower limit of the condition (11) may avoid an insufficient secondary spectrum correction. Selecting a material by avoiding being above an upper limit of the condition (11) may avoid an excessive secondary spectrum correction.

Assuming that f3 is a focal length of the third lens group, the lens system satisfies the following condition:

2.0<f3/f<5.5 (12)

The condition (12) is a condition about a relationship between the focal length of the third lens group for focusing and the focal length of the entire lens system. By avoiding being below a lower limit of the condition (12), the refractive power of the third lens group may be appropriately set and a focus stroke may be shortened to facilitate miniaturization. Avoiding being above an upper limit of the condition (12) may suppress variations of an image plane curvature and a spherical aberration when a distance is changed from infinity to a shortest distance.

In addition, satisfaction of the following condition (12-1) may make the foregoing effect more remarkable.

2.1<f3/f<4.7 (12-1)

In the lens system, all lenses are spherical lenses. Generally, in comparison with an aspheric lens, preparation time for manufacturing a spherical lens is shorter and manufacturing difficulty is lower. Therefore, the spherical lens is inexpensive. As all the lenses included in the lens system are spherical lenses, an inexpensive lens system can be provided.

Assuming that ω is a maximum half field angle of the lens system, the lens system satisfies the following condition:

−0.25<(Y−f·tan ω)/(f·tan ω)<−0.05 (13)

In the lens configuration in some exemplary embodiments, generation of a negative distortion is advantageous for achieving miniaturization and high performance. By using a generated optical distortion, a wider angle of view may be obtained. On the other hand, electrical image processing may be performed to correct a signal of an image formed on an image plane of a photographing element and containing a generated optical distortion, so that recording, displaying, or the like can be performed. Therefore, the optical system actively generates a negative distortion to achieve miniaturization and high performance. In addition, advantages of both miniaturization and high performance can be further taken by reducing the distortion of the captured image. The condition (13) is an example of the condition for achieving miniaturization of the imaging lens system and taking full advantages of the features of the foregoing structure included in the lens system. Avoiding being below a lower limit of the condition (13) to intentionally generate a negative distortion is advantageous for striking a balance between a wide angle of view and miniaturization. Avoiding being above an upper limit of the condition (13) can easily reduce an image plane curvature, suppress an increase of a quantity of lens elements of a front lens group for correcting an image plane curvature, and further achieve miniaturization. In addition, it is easy to suppress an increase of an incident angle of a ray of light incident on the image plane and having a maximum image height.

In addition, satisfaction of the following condition (13-1) may make the foregoing effect more remarkable.

−0.20<(Y−f·tan ω)/(f·tan ω)<−0.10 (13-1)

As described above, according to the lens system in some exemplary embodiments, a single-focus lens with a large aperture, a small size, a wide angle, and a low price can be obtained. In particular, because a positive front group, the aperture diaphragm, a positive rear group, and a focus group are arranged in sequence from the object side, the positive refractive power can be appropriately dispersed before and after the aperture diaphragm, and various aberrations can be easily corrected. In addition, variations of various aberrations during focusing may be suppressed. In addition, by satisfying the foregoing conditions, it is possible to implement a more miniature fixed-focus lens of an internal focus type with excellent imaging performance.

In addition, when the terms “including˜”, “comprising˜”, and “containing˜” are used in this disclosure, certain elements, such as liens that do not have a refractive power, diaphragms, and filters, non-lens optical elements that have a refractive power, for example, a glass cover, lens flanges, photographing elements, shake correction mechanisms, etc. may be additionally included on a basis of the listed constituent elements. For example, when the terms “including X”, “comprising X”, and “containing X” are used, a non-lens optical element that actually has a refractive power and/or a mechanism may be further included on a basis of X.

The following describes the lens configuration according to some exemplary embodiments of the lens system. First, meanings of signs or reference numbers and the like used in the description of the exemplary embodiments of the lens system are described.

In a table of lens data, a surface number is shown in a surface number column, a surface closest to the object side is used as a first surface, and the surface number increases sequentially toward the image side. An R column shows a curvature radius of each surface. A D column shows a surface spacing between each surface on the optical axis and an adjacent surface on the image side. In addition, an Nd column shows a refractive index of each optical element to the d-line (wavelength 587.6 nm (nanometers)), and a vd column shows an Abbe number of each optical element based on the d-line. A sign of a curvature radius is positive when a surface shape is convex toward the object side, and negative when a surface shape is convex toward the image plane. In addition, “∞” in the curvature radius indicates that the surface is a flat surface/plane.

The lens data also includes the aperture diaphragm ST, and the optical members PP1 and PP2. In addition to a surface number, the term (STO) is also described in the surface number column of a surface corresponding to the aperture diaphragm ST. In the lens data, D (surface number) is described in the surface spacing column of each spacing that changes during focusing.

“f” represents the focal length. “Fno” represents an F number. “ω” represents a half field angle (maximum half field angle). “Y” represents the maximum image height. “INF” represents an infinite focus state. “MOD” represents a closest focus state.

In the lens data, variable surface spacing data, and lens system specification data, “degree” is used as an angle unit, and “mm” is used as a length unit. However, because the lens system can be scaled up or scaled down, other suitable units can also be used.

In addition, when a photographing lens is mounted on a photographing apparatus, various filters such as a low-pass filter corresponding to specifications of the photographing apparatus and a glass cover used for protection are included. An example is provided in which parallel plate-shaped optical members PP1 and PP2 under these assumptions are arranged between the lens system and the image plane IM. However, locations of the optical members PP1 and PP2 are not limited to the locations shown in some exemplary embodiments. In addition, a configuration omitting both or one of the optical members PP1 and PP2 may be used.

“Li” represents a single lens. L is followed by a natural number i, which is used to identify a lens included in the lens system in some exemplary embodiments. In the description, a lens labeled as Lm in one embodiment may not be the same as a lens also labeled as Lm in another embodiment. “CLj” represents a cemented lens. CL is followed by a natural number j, which is used to identify a cemented lens included in the lens system in some exemplary embodiments. The letter “n” or “p” after “CLj” indicates that a lens constituting the cemented lens is a positive lens or a negative lens. Similarly, a cemented lens labeled with CLj may not be the same as a lens labeled with CLj in another embodiment. Likewise, a lens labeled with CLjn in one embodiment may not be the same as a lens also labeled with CLjn in another embodiment. Likewise, a lens labeled with CLjp may not be the same as a lens also labeled with CLjp in another embodiment.

FIG. 1 shows a lens configuration, optical members PP1 and PP2, and an image plane IM of a lens system 100 in some exemplary embodiments. The lens system 100 includes sequentially from an object side: a first lens group 110 having a positive refractive power, an aperture diaphragm ST, and a second lens group 120 having a positive refractive power. The first lens group 110 includes a negative meniscus lens L11, a lens L12, and a first cemented lens LC1 sequentially from the object side. The second lens group 120 includes a second cemented lens CL2 and a lens L21 sequentially from the object side. The third lens group 130 includes a lens L31. When focusing from an object at infinity to a close object, the third lens group 130 moves along a direction (Z) of an optical axis. All lenses constituting the lens system 100 are spherical lenses.

Table 1 shows lens data of the lens system 100.

TABLE 1

| Surface No. | R | D | Nd | Vd |
|---|---|---|---|---|
| 1 | 22.445 | 0.55 | 1.43700 | 95.10 |
| 2 | 4.584 | 3.02 | | |
| 3 | −7.478 | 2.78 | 1.91082 | 35.25 |
| 4 | −10.000 | 0.14 | | |
| 5 | 13.082 | 1.54 | 1.87070 | 40.73 |
| 6 | −13.082 | 0.50 | 1.80809 | 22.76 |
| 7 | −34.173 | 2.77 | | |
| 8(STO) | ∞ | 1.82 | | |
| 9 | −78.601 | 0.50 | 1.95375 | 32.32 |
| 10 | 8.039 | 2.68 | 1.72916 | 54.67 |
| 11 | −8.039 | 0.93 | | |
| 12 | −5.588 | 0.82 | 1.75211 | 25.05 |
| 13 | −7.934 | D[13] | | |
| 14 | 730.470 | 1.55 | 1.83481 | 42.72 |
| 15 | −25.800 | D[15] | | |
| 16 | ∞ | 0.30 | 1.51680 | 64.20 |
| 17 | ∞ | 0.27 | | |
| 18 | ∞ | 0.50 | 1.51680 | 64.20 |
| 19 | ∞ | 0.81 | | |

Table 2 shows surface spacing data in an infinite focus state and a closest focus state.

TABLE 2

| | INF | MOD |
|---|---|---|
| D[13] | 1.85 | 1.72 |
| D[15] | 7.07 | 7.20 |

Table 3 shows a focal length f, Fno, a half field angle ω, and an image height Y of the entire lens system 100 in the infinite focus state and the closest focus state.

TABLE 3

| | INF | MOD |
|---|---|---|
| f | 8.91 | 8.88 |
| Fno | 2.88 | 2.87 |
| ω | 41.68 | 41.67 |
| Y | 6.61 | 6.61 |

As described above, the lens system 100 may include three groups. The first lens group 110 may include sequentially from the object side: the negative meniscus lens L11 whose convex surface faces the object side, the lens L12, and the first cemented lens CL1 arranged closest to the aperture diaphragm ST. The second lens group 120 may include the second cemented lens CL2 arranged closest to the aperture diaphragm ST and the lens L21 sequentially from the object side. The lens L21 is a meniscus lens whose convex surface faces an image side. The third lens group 130 may include a single lens, that is, the lens L31. The first cemented lens CL1 includes a positive lens CL1p and a negative lens CL1n sequentially from the object side. The positive lens CL1p is cemented with the negative lens CL1n. The second cemented lens CL2 includes a negative lens CL2n and a positive lens CL2p sequentially from the object side. The negative lens CL2n is cemented with the positive lens CL2p.

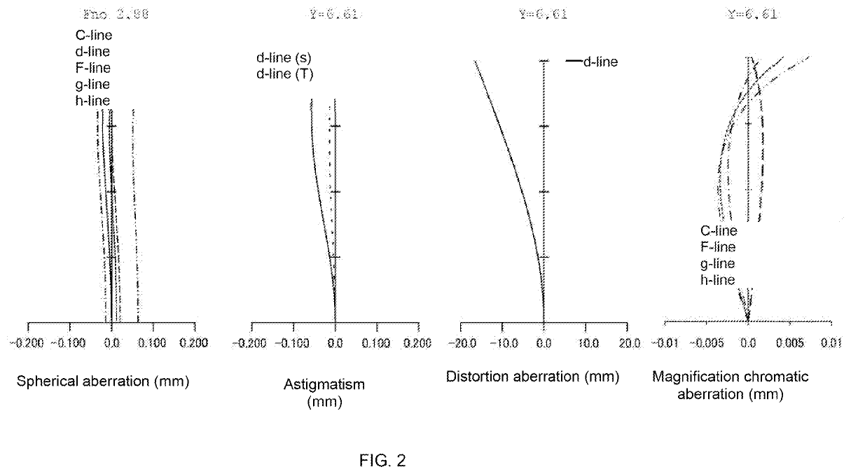

FIG. 2 shows a spherical aberration, astigmatism, a distortion aberration, and a magnification chromatic aberration of the lens system 100 in the infinite focus state. Aberration diagrams representing the spherical aberration, astigmatism, distortion aberration, and magnification chromatic aberration show aberrations with a d-line (wavelength 587.6 nm) as a reference wavelength. In the spherical aberration diagram, aberrations of a C-line (wavelength 656.3 nm), the d-line (wavelength 587.6 nm), an F-line (wavelength 486.1 nm), a g-line (wavelength 435.8 nm), and a h-line (wavelength 404.7 nm) are respectively represented by a long dashed line, a solid line, a single dotted line, a short dashed line, and a double dotted line. In the astigmatism diagram, aberrations in a sagittal direction (S) and a tangential direction (T) are respectively represented by a solid line and a short dashed line. In the distortion aberration diagram, a value of the d-line is represented by a solid line. In the magnification chromatic aberration diagram, aberrations of the C-line (wavelength 656.3 nm), the F-line (wavelength 486.1 nm), the g-line (wavelength 435.8 nm), and the h-line (wavelength 404.7 nm) are respectively represented by a long dashed line, a single dotted line, a short dashed line, and a double dotted line. In addition, FNo in the spherical aberration diagram represents an F number. Y in the other aberration diagrams represents a maximum image height. As can be learned from the aberration diagrams, in the lens system 100, various aberrations are apparently well corrected, and is the lens system has excellent imaging performance.

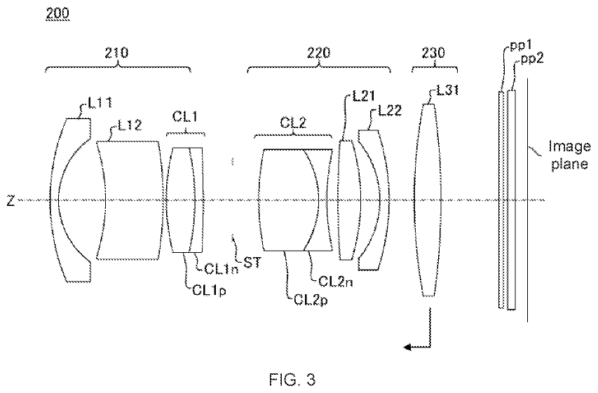

FIG. 3 shows a lens configuration, optical members PP1 and PP2, and an image plane IM of a lens system 200 in some exemplary embodiments. The lens system 200 sequentially includes from an object side: a first lens group 210 having a positive refractive power, an aperture diaphragm ST, and a third lens group 230 having a positive refractive power. The first lens group 210 includes a negative meniscus lens L11, a lens L12, and a first cemented lens CL1 sequentially from the object side. The second lens group 220 includes a second cemented lens CL2, a lens L21, and a lens L22 sequentially from the object side. The third lens group 230 includes a lens L31. When focusing from an object at infinity to a close object, the third lens group 230 moves along a direction (Z) of an optical axis. All lenses constituting the lens system 200 are spherical lenses.

Table 4 shows lens data of the lens system 200.

TABLE 4

| Surface No. | R | D | Nd | Vd |
|---|---|---|---|---|
| 1 | 13.652 | 0.55 | 1.55032 | 75.50 |
| 2 | 4.948 | 3.05 | | |
| 3 | −12.013 | 3.74 | 1.94595 | 17.98 |
| 4 | −22.019 | 0.20 | | |
| 5 | 13.694 | 1.85 | 2.00912 | 29.13 |
| 6 | −15.734 | 0.55 | 1.93323 | 20.88 |
| 7 | −70.696 | 1.89 | | |
| 8(STO) | ∞ | 1.70 | | |
| 9 | 15.778 | 3.89 | 1.80831 | 46.50 |
| 10 | −5.950 | 0.52 | 1.81263 | 25.46 |
| 11 | 13.912 | 0.73 | | |
| 12 | 59.342 | 1.48 | 2.00912 | 29.13 |
| 13 | −13.033 | 1.23 | | |
| 14 | −6.000 | 0.60 | 1.75918 | 25.05 |
| 15 | −14.571 | D[15] | | |
| 16 | 33.533 | 1.74 | 1.96073 | 32.32 |
| 17 | −43.858 | D[17] | | |
| 18 | ∞ | 0.30 | 1.51680 | 64.20 |
| 19 | ∞ | 0.27 | | |
| 20 | ∞ | 0.50 | 1.51680 | 64.20 |
| 21 | ∞ | 0.81 | | |

Table 5 shows surface spacing data in an infinite focus state and a closest focus state.

TABLE 5

| | INF | MOD |
|---|---|---|
| D[15] | 1.64 | 1.50 |
| D[17] | 3.75 | 3.89 |

Table 6 shows a focal length f, Fno, a half field angle ω, and an image height Y of the entire lens system 200 in the infinite focus state and the closest focus state.

TABLE 6

| | INF | MOD |
|---|---|---|
| f | 8.85 | 8.81 |
| Fno | 2.88 | 2.86 |
| ω | 41.87 | 40.91 |
| Y | 6.64 | 6.64 |

As described above, the lens system 200 may include three groups. The first lens group 210 includes sequentially from the object side: the negative meniscus lens L11 whose convex surface faces the object side, the lens L12, and the first cemented lens CL1 arranged closest to the aperture diaphragm ST. The second lens group 220 includes the second cemented lens CL2 arranged closest to the aperture diaphragm ST, the lens L21, and the lens L22 sequentially from the object side. The lens L22 is a meniscus lens whose convex surface faces an image side. The third lens group 230 includes a single lens, that is, the lens L31. The first cemented lens CL1 includes a positive lens CL1p and a negative lens CL1n. The positive lens CL1p is cemented with the negative lens CL1n. The second cemented lens CL2 includes a positive lens CL2p and a negative lens CL2n. The positive lens CL2p is cemented with the negative lens CL2n.

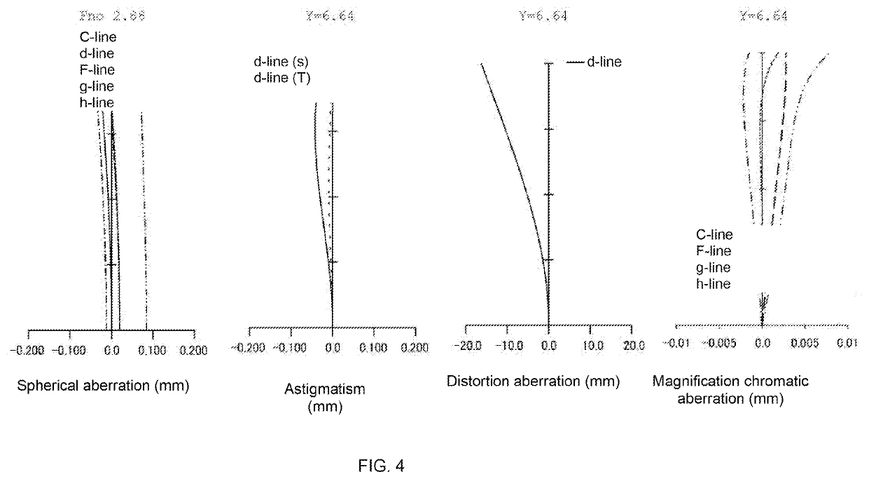

FIG. 4 shows a spherical aberration, astigmatism, a distortion aberration, and a magnification chromatic aberration of the lens system 200 in an infinite focus state. Aberration diagrams representing the spherical aberration, astigmatism, distortion aberration, and magnification chromatic aberration show aberrations with a d-line (wavelength 587.6 nm) as a reference wavelength. In the spherical aberration diagram, aberrations of a C-line (wavelength 656.3 nm), the d-line (wavelength 587.6 nm), an F-line (wavelength 486.1 nm), a g-line (wavelength 435.8 nm), and a h-line (wavelength 404.7 nm) are respectively represented by a long dashed line, a solid line, a single dotted line, a short dashed line, and a double dotted line. In the astigmatism diagram, aberrations in a sagittal direction (S) and a tangential direction (T) are respectively represented by a solid line and a short dashed line. In the distortion aberration, a value of the d-line is represented by a solid line. In the magnification chromatic aberration diagram, aberrations of the C-line (wavelength 656.3 nm), the F-line (wavelength 486.1 nm), the g-line (wavelength 435.8 nm), and the h-line (wavelength 404.7 nm) are respectively represented by a long dashed line, a single dotted line, a short dashed line, and a double dotted line. In addition, FNo in the spherical aberration diagram represents an F number. Y in the other aberration diagrams represents a maximum image height. For the lens system, it is obvious from the aberration diagrams that various aberrations of the lens system 200 are well corrected, and is the lens system has excellent imaging performance.

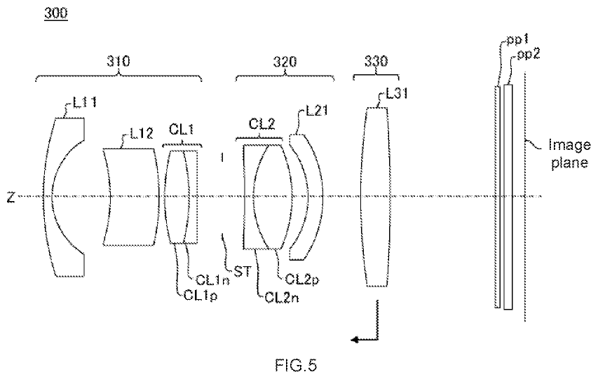

FIG. 5 shows a lens configuration, optical members PP1 and PP2, and an image plane IM of a lens system 300 in some exemplary embodiments. The lens system 300 includes sequentially from an object side: a first lens group 310 having a positive refractive power, an aperture diaphragm ST, and a third lens group 330 having a positive refractive power. The first lens group 310 includes a negative meniscus lens L11, a lens L12, and a first cemented lens CL1 sequentially from the object side. The second lens group 320 includes a second cemented lens CL2 and a lens L21 sequentially from the object side. The third lens group 330 includes a lens L31. When focusing from an object at infinity to a close object, the third lens group 330 moves along a direction (Z) of an optical axis. All lenses constituting the lens system 300 are spherical lenses.

Table 7 shows lens data of the lens system 300.

TABLE 7

| Surface No. | R | D | Nd | Vd |
|---|---|---|---|---|
| 1 | 16.241 | 0.55 | 1.43700 | 95.10 |
| 2 | 4.264 | 3.68 | | |
| 3 | −9.886 | 3.08 | 1.92286 | 20.88 |
| 4 | −13.383 | 0.34 | | |
| 5 | 11.525 | 1.55 | 1.8707 | 40.73 |
| 6 | −12.023 | 0.50 | 1.5927 | 35.45 |
| 7 | ∞ | 1.60 | | |
| 8(STO) | ∞ | 1.42 | | |
| 9 | −34.524 | 0.54 | 1.90366 | 31.31 |
| 10 | 6.077 | 2.44 | 1.72916 | 54.67 |
| 11 | −7.958 | 1.02 | | |
| 12 | −5.236 | 0.94 | 1.75211 | 25.05 |
| 13 | −7.079 | D[13] | | |
| 14 | 39.589 | 1.85 | 1.87070 | 40.73 |
| 15 | −79.482 | D[15] | | |
| 16 | ∞ | 0.30 | 1.51680 | 64.20 |
| 17 | ∞ | 0.27 | | |
| 18 | ∞ | 0.50 | 1.51680 | 64.20 |
| 19 | ∞ | 0.81 | | |

Table 8 shows surface spacing data in an infinite focus state and a closest focus state.

TABLE 8

| | INF | MOD |
|---|---|---|
| D[13] | 2.38 | 2.25 |
| D[15] | 6.64 | 6.77 |

Table 9 shows a focal length f, Fno, a half field angle ω, and an image height Y of the entire lens system 300 in the infinite focus state and the closest focus state.

TABLE 9

| | INF | MOD |
|---|---|---|
| f | 8.91 | 8.88 |
| Fno | 2.85 | 2.84 |
| ω | 41.68 | 41.67 |
| Y | 6.62 | 6.62 |

As described above, the lens system 300 may include three groups. The first lens group 310 includes sequentially from the object side: the negative meniscus lens L11 whose convex surface faces the object side, the lens L12, and the first cemented lens CL1 arranged closest to the aperture diaphragm ST. The second lens group 320 includes the second cemented lens CL2 arranged closest to the aperture diaphragm ST and the lens L21 sequentially from the object side. The lens L22 is a meniscus lens whose convex surface faces an image side. The third lens group 330 includes a single lens, that is, the lens L31. The first cemented lens CL1 includes a positive lens CL1p and a negative lens CL1n. The positive lens CL1p is cemented with the negative lens CL1n. The second cemented lens CL2 includes a negative lens CL2n and a positive lens CL2p. The negative lens CL2n is cemented with the positive lens CL2p.

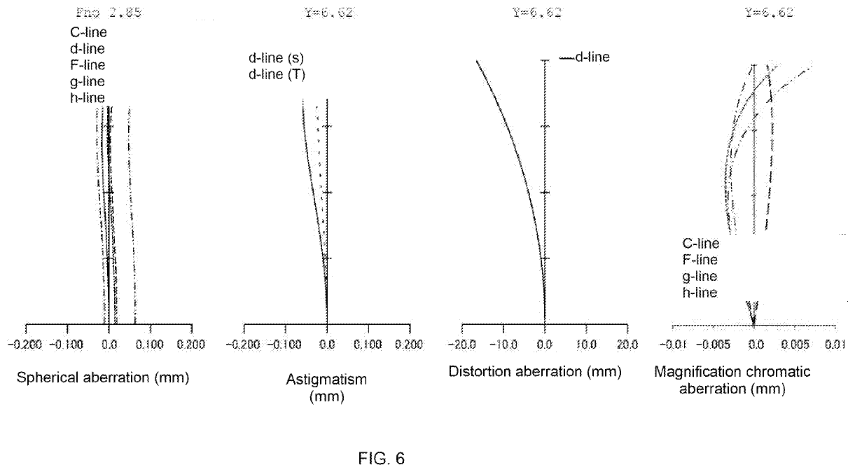

FIG. 6 shows a spherical aberration, astigmatism, a distortion aberration, and a magnification chromatic aberration of the lens system 300 in an infinite focus state. Aberration diagrams representing the spherical aberration, astigmatism, distortion aberration, and magnification chromatic aberration show aberrations with a d-line (wavelength 587.6 nm) as a reference wavelength. In the spherical aberration diagram, aberrations of a C-line (wavelength 656.3 nm), the d-line (wavelength 587.6 nm), an F-line (wavelength 486.1 nm), a g-line (wavelength 435.8 nm), and a h-line (wavelength 404.7 nm) are respectively represented by a long dashed line, a solid line, a single dotted line, a short dashed line, and a double dotted line. In the astigmatism diagram, aberrations in a sagittal direction (S) and a tangential direction (T) are respectively represented by a solid line and a short dashed line. In the distortion aberration, a value of the d-line is represented by a solid line. In the magnification chromatic aberration diagram, aberrations of the C-line (wavelength 656.3 nm), the F-line (wavelength 486.1 nm), the g-line (wavelength 435.8 nm), and the h-line (wavelength 404.7 nm) are respectively represented by a long dashed line, a single dotted line, a short dashed line, and a double dotted line. In addition, FNo in the spherical aberration diagram represents an F number. Y in the other aberration diagrams represents a maximum image height. For the lens system, it is obvious in the aberration diagrams that various aberrations of the lens system 300 are well corrected, and is the lens system has excellent imaging performance.

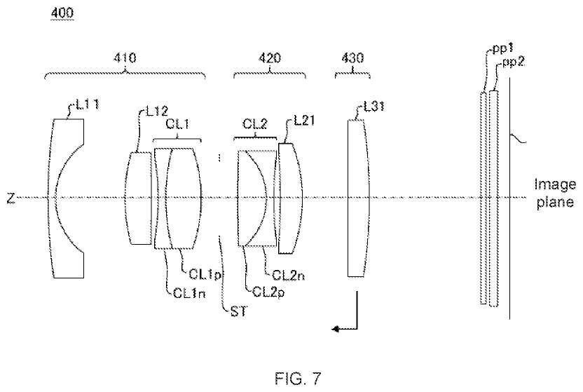

FIG. 7 shows a lens configuration, optical members PP1 and PP2, and an image plane IM of a lens system 400 in some exemplary embodiments. The lens system 400 sequentially includes from an object side: a first lens group 410 having a positive refractive power, an aperture diaphragm ST, and a third lens group 430 having a positive refractive power. The first lens group 410 includes a negative meniscus lens L11, a lens L12, and a first cemented lens CL1 sequentially from the object side. The second lens group 420 includes a second cemented lens CL2 and a lens L21 sequentially from the object side. The third lens group 430 includes a lens L31. When focusing from an object at infinity to a close object, the third lens group 430 moves along a direction (Z) of an optical axis. All lenses constituting the lens system 400 are spherical lenses.

Table 10 shows lens data of the lens system 400.

TABLE 10

| Surface No. | R | D | Nd | Vd |
|---|---|---|---|---|
| 1 | 35.232 | 0.50 | 1.61997 | 63.88 |
| 2 | 4.433 | 4.56 | | |
| 3 | 11.450 | 1.74 | 1.85478 | 24.80 |
| 4 | 419.955 | 0.44 | | |
| 5 | −16.666 | 0.50 | 1.89286 | 20.36 |
| 6 | 13.124 | 2.35 | 1.95375 | 32.32 |
| 7 | −9.833 | 1.20 | | |
| 8(STO) | ∞ | 1.20 | | |
| 9 | 99.597 | 1.88 | 1.49700 | 81.61 |
| 10 | −4.174 | 0.50 | 1.72825 | 28.32 |
| 11 | 24.972 | 0.42 | | |
| 12 | −42.494 | 1.45 | 2.00100 | 29.13 |
| 13 | −10.159 | D[13] | | |
| 14 | −2355.256 | 1.42 | 1.80420 | 46.50 |
| 15 | −32.100 | D[15] | | |
| 16 | ∞ | 0.30 | 1.51680 | 64.20 |
| 17 | ∞ | 0.27 | | |
| 18 | ∞ | 0.50 | 1.51680 | 64.20 |
| 19 | ∞ | 0.81 | | |

Table 11 shows surface spacing data in an infinite focus state and a closest focus state.

TABLE 11

| | INF | MOD |
|---|---|---|
| D[13] | 3.00 | 2.82 |
| D[15] | 7.36 | 7.54 |

Table 12 shows a focal length f, Fno, a half field angle ω, and an image height Y of the entire lens system 400 in the infinite focus state and the closest focus state.

TABLE 12

| | INF | MOD |
|---|---|---|
| f | 8.84 | 8.81 |
| Fno | 2.89 | 2.88 |
| ω | 41.92 | 41.92 |
| Y | 6.62 | 6.62 |

As described above, the lens system 400 may include three groups. The first lens group 410 includes sequentially from the object side: the negative meniscus lens L11 whose convex surface faces the object side, the lens L12, and the first cemented lens CL1 arranged closest to the aperture diaphragm ST. The second lens group 420 includes the second cemented lens CL2 arranged closest to the aperture diaphragm ST and the lens L21 sequentially from the object side. The lens L21 has a convex surface on an image side. The third lens group 430 includes a single lens, that is, the lens L31. The first cemented lens CL1 includes a negative lens CL1n and a positive lens CL1p. The negative lens CL1n is cemented with the positive lens CL1p. The second cemented lens CL2 includes a positive lens CL2p and a negative lens CL2n. The positive lens CL2p is cemented with the negative lens CL2n.

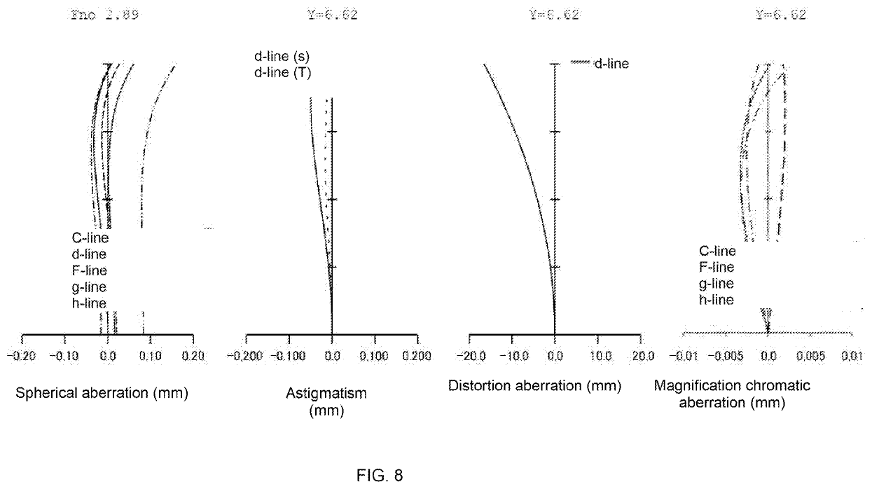

FIG. 8 shows a spherical aberration, astigmatism, a distortion aberration, and a magnification chromatic aberration of the lens system 400 in an infinite focus state. Aberration diagrams representing the spherical aberration, astigmatism, distortion aberration, and magnification chromatic aberration show aberrations with a d-line (wavelength 587.6 nm) as a reference wavelength. In the spherical aberration diagram, aberrations of a C-line (wavelength 656.3 nm), the d-line (wavelength 587.6 nm), an F-line (wavelength 486.1 nm), a g-line (wavelength 435.8 nm), and a h-line (wavelength 404.7 nm) are respectively represented by a long dashed line, a solid line, a single dotted line, a short dashed line, and a double dotted line. In the astigmatism diagram, aberrations in a sagittal direction (S) and a tangential direction (T) are respectively represented by a solid line and a short dashed line. In the distortion aberration, a value of the d-line is represented by a solid line. In the magnification chromatic aberration diagram, aberrations of the C-line (wavelength 656.3 nm), the F-line (wavelength 486.1 nm), the g-line (wavelength 435.8 nm), and the h-line (wavelength 404.7 nm) are respectively represented by a long dashed line, a single dotted line, a short dashed line, and a double dotted line. In addition, FNo in the spherical aberration diagram represents an F number. Y in the other aberration diagrams represents a maximum image height. For the lens system, it is obvious in the aberration diagrams that various aberrations of the lens system 400 are well corrected, and is the lens system has excellent imaging performance.

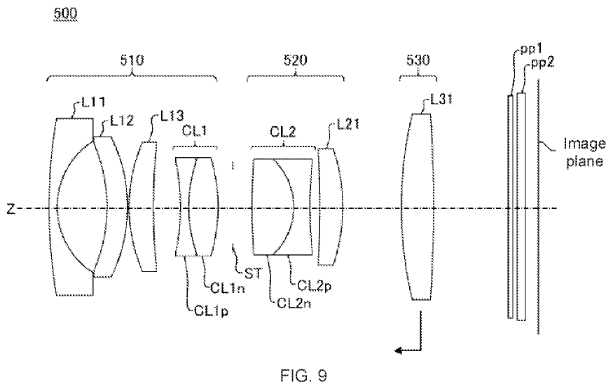

FIG. 9 shows a lens configuration, optical members PP1 and PP2, and an image plane IM of a lens system 500 in some exemplary embodiments. The lens system 500 includes sequentially from an object side: a first lens group 510 having a positive refractive power, an aperture diaphragm ST, and a third lens group 530 having a positive refractive power. The first lens group 510 includes a negative meniscus lens L11, a lens L12, a lens L13, and a first cemented lens CL1 sequentially from the object side. The second lens group 520 includes a second cemented lens CL2 and a lens L21 sequentially from the object side. The third lens group 530 includes a lens L31. When focusing from an object at infinity to a close object, the third lens group 530 moves along a direction (Z) of an optical axis. All lenses constituting the lens system 500 are spherical lenses.

Table 13 shows lens data of the lens system 500.

TABLE 13

| Surface No. | R | D | Nd | Vd |
|---|---|---|---|---|
| 1 | 33.156 | 0.50 | 1.6516 | 58.55 |
| 2 | 4.897 | 3.09 | | |
| 3 | −10.197 | 1.27 | 1.95375 | 32.32 |
| 4 | −9.870 | 0.10 | | |
| 5 | 10.228 | 1.51 | 1.91082 | 35.25 |
| 6 | 34.483 | 1.69 | | |
| 7 | −13.472 | 0.50 | 1.85896 | 22.73 |
| 8 | 8.762 | 1.83 | 2.00100 | 29.13 |
| 9 | −10.599 | 0.90 | | |
| 10(STO) | ∞ | 1.20 | | |
| 11 | 37.965 | 2.60 | 1.49700 | 81.61 |
| 12 | −4.038 | 1.01 | 1.67270 | 32.10 |
| 13 | 24.887 | 0.62 | | |
| 14 | −59.567 | 1.41 | 1.95375 | 32.32 |
| 15 | −11.507 | D[15] | | |
| 16 | 24.952 | 2.00 | 1.49700 | 81.61 |
| 17 | −84.618 | D[17] | | |
| 18 | ∞ | 0.30 | 1.51680 | 64.20 |
| 19 | ∞ | 0.27 | | |
| 20 | ∞ | 0.50 | 1.51680 | 64.20 |
| 21 | ∞ | 0.81 | | |

Table 14 shows surface spacing data in an infinite focus state and a closest focus state.

TABLE 14

| | INF | MOD |
|---|---|---|
| D[15] | 3.65 | 3.39 |
| D[17] | 4.64 | 4.9 |

Table 15 shows a focal length f, Fno, a half field angle ω, and an image height Y of the entire lens system 500 in the infinite focus state and the closest focus state.

TABLE 15

| | INF | MOD |
|---|---|---|
| f | 8.83 | 8.78 |
| Fno | 2.87 | 2.86 |
| ω | 41.92 | 41.99 |
| Y | 6.61 | 6.61 |

As described above, the lens system 500 may include three groups. The first lens group 510 includes sequentially from the object side: the negative meniscus lens L11 whose convex surface faces the object side, the lens L12, the lens L13, and the first cemented lens CL1 arranged closest to the aperture diaphragm ST. The second lens group 520 includes the second cemented lens CL2 arranged closest to the aperture diaphragm ST and the lens L21 sequentially from the object side. The lens L21 has a convex surface on an image side. The third lens group 530 includes a single lens, that is, the lens L31. The first cemented lens CL1 includes a negative lens CL1n and a positive lens CL1p. The negative lens CL1n is cemented with the positive lens CL1p. The second cemented lens CL2 includes a positive lens CL2p and a negative lens CL2n. The positive lens CL2p is cemented with the negative lens CL2n.

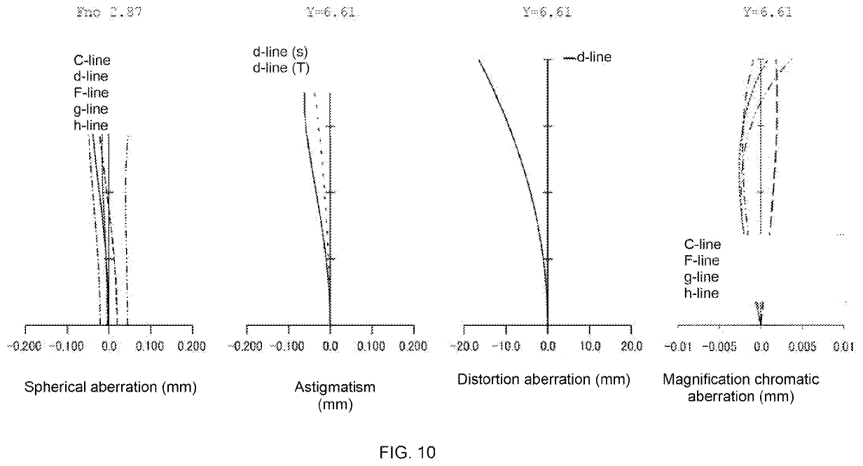

FIG. 10 shows a spherical aberration, astigmatism, a distortion aberration, and a magnification chromatic aberration of the lens system 500 in an infinite focus state. Aberration diagrams representing the spherical aberration, astigmatism, distortion aberration, and magnification chromatic aberration show aberrations with a d-line (wavelength 587.6 nm) as a reference wavelength. In the spherical aberration diagram, aberrations of a C-line (wavelength 656.3 nm), the d-line (wavelength 587.6 nm), an F-line (wavelength 486.1 nm), a g-line (wavelength 435.8 nm), and a h-line (wavelength 404.7 nm) are respectively represented by a long dashed line, a solid line, a single dotted line, a short dashed line, and a double dotted line. In the astigmatism diagram, aberrations in a sagittal direction (S) and a tangential direction (T) are respectively represented by a solid line and a short dashed line. In the distortion aberration, a value of the d-line is represented by a solid line. In the magnification chromatic aberration diagram, aberrations of the C-line (wavelength 656.3 nm), the F-line (wavelength 486.1 nm), the g-line (wavelength 435.8 nm), and the h-line (wavelength 404.7 nm) are respectively represented by a long dashed line, a single dotted line, a short dashed line, and a double dotted line. In addition, FNo in the spherical aberration diagram represents an F number. Y in the other aberration diagrams represents a maximum image height. For the lens system, it is obvious from the aberration diagrams that various aberrations of the lens system 500 are well corrected, and is the lens system has excellent imaging performance.

Table 16 shows numerical values related to each condition in some exemplary embodiments. Table 17 shows numerical values related to conditions (1) to (13). The values shown in Table 16 and Table 17 are values using the d-line as the reference wavelength.

TABLE 16

| Conditional | | Emb 1 | Emb 2 | Emb 3 | Emb 4 | Emb 5 |
|---|---|---|---|---|---|---|
| Conditional (1) | L/Y | 1.290 | 1.497 | 1.465 | 1.524 | 1.587 |
| Conditional (2) | f1/f | 1.871 | 2.781 | 1.533 | 1.255 | 1.427 |
| Conditional (3) | fL11/f | −1.314 | −1.630 | −1.506 | −0.931 | −1.006 |
| Conditional (4) | fCL1/f1 | 1.207 | 1.261 | 1.154 | 2.050 | 2.142 |
| Conditional (5) | NCL1p − NCL1n | 0.063 | 0.076 | 0.278 | 0.061 | 0.142 |
| Conditional (6) | VCL1p − VCL1n | 17.97 | 8.25 | 5.28 | 11.96 | 6.40 |
| Conditional (7) | θCL1p − θCL1n | −0.060 | −0.039 | −0.024 | −0.049 | −0.029 |
| Conditional (8) | NCL2p − NCL2n | −0.225 | −0.004 | −0.175 | −0.231 | −0.176 |
| Conditional (9) | θCL2p − θCL2n | −0.045 | −0.058 | −0.050 | −0.067 | −0.060 |
| Conditional (10) | VL11 | 95.10 | 75.50 | 95.10 | 63.88 | 58.55 |
| Conditional (11) | θgL11 + 0.001625 × VL11 | 0.688 | 0.663 | 0.688 | 0.646 | 0.638 |
| Conditional (12) | f3/f | 3.353 | 2.276 | 3.431 | 4.576 | 4.418 |
| Conditional (13) | (Y − f × tanω)/(f × tanω) | −0.167 | −0.163 | −0.166 | −0.166 | −0.166 |

Note:
Emb stands for embodiment.

TABLE 17

| | Emb 1 | Emb 2 | Emb 3 | Emb 4 | Emb 5 |
|---|---|---|---|---|---|
| Y | 6.61 | 6.64 | 6.62 | 6.62 | 6.61 |
| ω | 41.68 | 41.87 | 41.68 | 41.92 | 41.92 |
| L | 8.53 | 9.94 | 9.70 | 10.09 | 10.49 |
| f | 8.91 | 8.85 | 8.91 | 8.84 | 8.83 |
| f1 | 16.669 | 24.612 | 13.658 | 11.0962 | 12.599 |
| f3 | 29.879 | 20.145 | 30.5716 | 40.4562 | 39.009 |
| fL11 | −11.710 | −14.426 | −13.4199 | −8.23096 | −8.879 |
| fCL1 | 10.756 | 11.160 | 10.285 | 18.1187 | 18.912 |
| VL11 | 95.1 | 75.5 | 95.10 | 63.88 | 58.55 |
| θgL11 | 0.5334 | 0.5400 | 0.5334 | 0.5425 | 0.5425 |
| NCL1p | 1.8707 | 2.00912 | 1.8707 | 1.95375 | 2.001 |
| NCL1n | 1.80809 | 1.93323 | 1.5927 | 1.89286 | 1.85896 |
| VCL1p | 40.73 | 29.13 | 40.73 | 32.32 | 29.13 |
| VCLin | 22.76 | 20.88 | 35.45 | 20.36 | 22.73 |
| θCL1p | 0.5682 | 0.5994 | 0.5682 | 0.5901 | 0.5994 |
| θCL1n | 0.6286 | 0.6388 | 0.5926 | 0.6393 | 0.6284 |
| NCL2p | 1.72916 | 1.80831 | 1.72916 | 1.49700 | 1.49700 |
| NCL2n | 1.95375 | 1.81263 | 1.90366 | 1.72825 | 1.67270 |
| θCL2p | 0.5452 | 0.5572 | 0.5452 | 0.5388 | 0.5388 |
| θCL2n | 0.5901 | 0.6156 | 0.5947 | 0.6058 | 0.5988 |

From the foregoing data, it can be seen that the lens system in some exemplary embodiments is actually a single-focus lens with a large aperture, a small size, and a wide angle, with the magnification chromatic aberration well corrected, and having high optical performance. In addition, since the lens system includes only spherical lenses, a manufacturing cost can be reduced. In addition, since the lens group responsible for focusing can include only one lens, a weight of the lens group responsible for focusing can be reduced, and further, high-speed focusing can be implemented.

The configurations included in the foregoing lens system may be combined, and may be appropriately and selectively used according to required specifications. For example, on a basis of satisfying the conditions (1) and (2), the lens system based on this implementation may satisfy any one of the conditions (1) to (13), (1-1), (2-1), (3-1), (4-1), (12-1), and (13-1), or may satisfy any combination of these conditions.

The present disclosure has been described above by illustrating the implementations and some exemplary embodiments. However, the present disclosure is not limited to the foregoing implementations and exemplary embodiments, and various modifications may be made. For example, the curvature radius, surface spacing, refractive index, and Abbe number of each lens are not limited to the values shown in the foregoing exemplary embodiments, and other values may be used.

The lens system in this implementation may be be applied to a photographing apparatus such as a digital camera or a video camera. The lens system in this disclosure may be applied to a lens system that does not have a zoom mechanism. The lens system in this disclosure may be applied to an aerial camera, a surveillance camera, or the like. The lens system in this disclosure may be applied to a non-interchangeable lens photographing apparatus. The lens system in this disclosure may be applied to an interchangeable lens of an interchangeable lens camera such as a single-lens reflex camera.

As an example of a system including the lens system in this disclosure, a movable object system is hereinafter described.

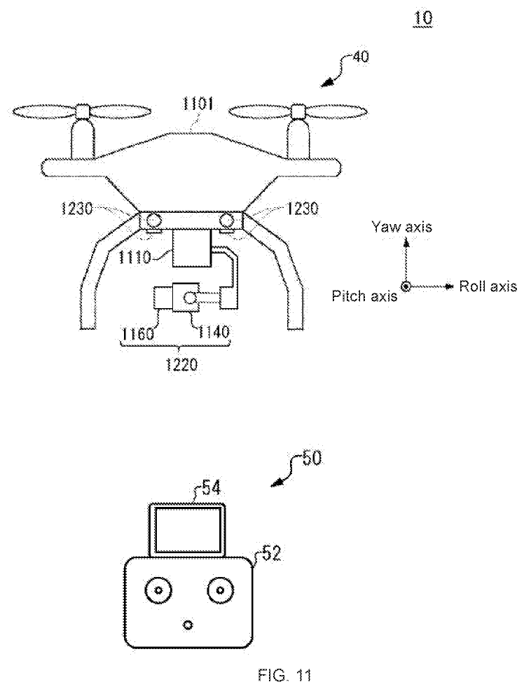

FIG. 11 schematically shows an example of a movable object system 10 including an unmanned aerial vehicle (UAV) 40 and a controller 50. The UAV 40 may include a UAV body 1101, a universal joint 1110, a plurality of photographing apparatuses 1230, and a photographing apparatus 1220. The photographing apparatus 1220 includes a lens device 1160 and a photographing portion 1140. The lens device 1160 includes the lens system described above. The UAV 40 is an example of a movable object that includes the photographing apparatus having the lens system and is capable of moving. The movable object refers to a concept that includes other airplanes moving in the air, vehicles moving on the ground, and ships moving on the water, in addition to UAVs.

The UAV body 1101 may include a plurality of rotors. The UAV body 1101 enables the UAV 40 to fly by controlling rotation of the plurality of rotors. The UAV body 1101 may use, for example, four rotors to enable the UAV 40 to fly. A quantity of rotors is not limited to four. Alternatively, the UAV 40 may be a fixed-wing aircraft without rotors.

The photographing apparatus 1230 may be a photographing camera that captures a photographed object included in an expected photographing range. The plurality of photographing apparatuses 1230 may be sensing cameras that photograph surroundings of the UAV 40 to control flight of the UAV 40. The photographing apparatuses 1230 may be fixed to the UAV body 1101.

Two photographing apparatuses 1230 may be disposed on a head of the UAV 40, that is, on a front side. In addition, other two photographing apparatuses 1230 may be disposed on a bottom side of the UAV 40. The two photographing apparatuses 1230 on the front side may be paired to function as a stereo camera. The two photographing apparatuses 1230 on the bottom side may also be paired to function as a stereo camera. Three-dimensional spatial data around the UAV 40 may be generated based on images captured by the plurality of photographing apparatuses 1230. A distance to the photographed object captured by the plurality of photographing apparatuses 1230 can be determined by the stereo cameras of the plurality of photographing apparatuses 1230.

A quantity of photographing apparatuses 1230 included in the UAV 40 is not limited to four. The UAV 40 may include at least one photographing apparatus 1230. Alternatively, the UAV 40 may include at least one photographing apparatus 1230 on each of the head, tail, lateral sides, bottom side, and top side of the UAV 40. The photographing apparatus 1230 may also have a single-focus lens or a fisheye lens. In the description related to the UAV 40, the plurality of photographing apparatuses 1230 may simply be collectively referred to as the photographing apparatuses 1230 in some cases.

The controller 50 may include a display portion 54 and an operation portion 52. The operation portion 52 receives an input operation of a user for controlling a posture of the UAV 40. Based on the user's operation received by the operation portion 52, the controller 50 sends a signal for controlling the UAV 40.

The controller 50 receives an image captured by at least one of the photographing apparatuses 1230 and the photographing apparatus 1220. The display portion 54 displays the image received by the controller 50. The display portion 54 may be a touch panel. The controller 50 may receive the user's input operation through the display portion 54. The display portion 54 may receive the user's operation or the like to specify a location of the photographed object to be photographed by the photographing apparatus 1220.

The photographing portion 1140 generates and records image data of an optical image formed by the lens device 1160. The lens device 1160 may be integrally disposed on the photographing portion 1140. The lens device 1160 may be an interchangeable lens. The lens device 1160 may be detachably disposed relative to the photographing portion 1140.

The universal joint 1110 has a supporting mechanism that movably supports the photographing apparatus 1220. The photographing apparatus 1220 is mounted on the UAV body 1101 via the universal joint 1110. The universal joint 1110 rotatably supports the photographing apparatus 1220 around a pitch axis. The universal joint 1110 rotatably supports the photographing apparatus 1220 around a roll axis. The universal joint 1110 rotatably supports the photographing apparatus 1220 around a yaw axis. The universal joint 1110 may rotatably support the photographing apparatus 1220 around at least one of the pitch axis, the roll axis, or the yaw axis. The universal joint 1110 may rotatably support the photographing apparatus 1220 around the pitch axis, the roll axis, and the yaw axis separately. The universal joint 1110 may also hold the photographing portion 1140. The universal joint 1110 may also hold the lens device 1160. The universal joint 1110 may rotate the photographing portion 1140 and the lens device 1160 around at least one of the yaw axis, the pitch axis, and the roll axis, thereby changing a photographing direction of the photographing apparatus 1220.

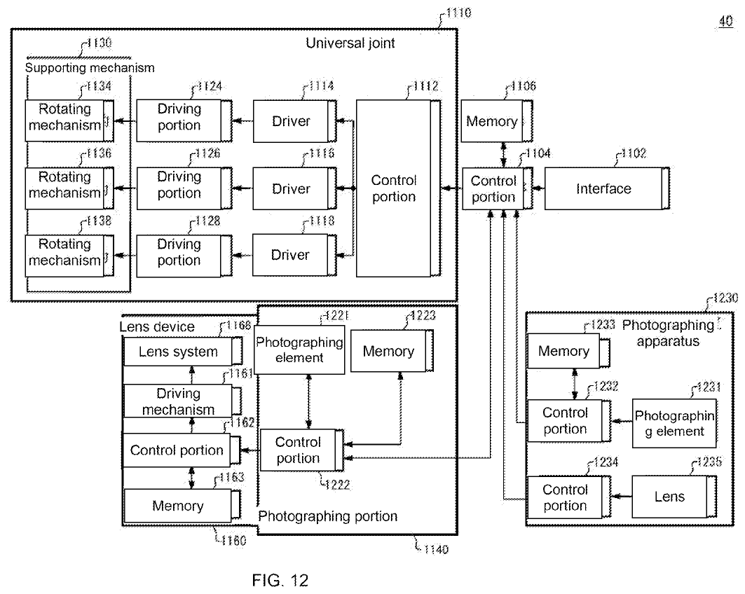

FIG. 12 shows an example of functional blocks of the UAV 40. The UAV 40 may include an interface 1102, a control portion 1104, a memory 1106, the universal joint 1110, the photographing portion 1140, and the lens device 1160.

The interface 1102 communicates with the controller 50. The interface 1102 receives various instructions from the controller 50. The control portion 1104 controls flight of the UAV 40 according to instructions received from the controller 50. The control portion 1104 controls the universal joint 1110, the photographing portion 1140, and the lens device 1160. The control portion 1104 may include a microprocessor such as a CPU or an MPU, or a microcontroller such as an MCU. The memory 1106 stores programs and the like required for the control portion 1104 to control the universal joint 1110, the photographing portion 1140, and the lens device 1160.

The memory 1106 may be a computer-readable storage medium. The memory 1106 may include at least one of a SRAM, a DRAM, an EPROM, an EEPROM, or a flash memory such as a USB memory. The memory 1106 may be disposed in a housing of the UAV 40. The memory 1106 may be detachably disposed in the housing of the UAV 40.

The universal joint 1110 may include a control portion 1112, a driver 1114, a driver 1116, a driver 1118, a driving portion 1124, a driving portion 1126, a driving portion 1128, and a supporting mechanism 1130. The driving portion 1124, the driving portion 1126, and the driving portion 1128 may be motors.

The supporting mechanism 1130 may support the photographing apparatus 1220. The supporting mechanism 1130 movably supports the photographing apparatus 1220 in the photographing direction. The supporting mechanism 1130 rotatably supports the photographing portion 1140 and the lens device 1160 around the yaw axis, the pitch axis, and the roll axis. The supporting mechanism 1130 includes a rotating mechanism 1134, a rotating mechanism 1136, and a rotating mechanism 1138. The rotating mechanism 1134 uses the driving portion 1124 to rotate the photographing portion 1140 and the lens device 1160 around the yaw axis. The rotating mechanism 1136 uses the driving portion 1126 to rotate the photographing portion 1140 and the lens device 1160 around the pitch axis. The rotating mechanism 1138 uses the driving portion 1128 to rotate the photographing portion 1140 and the lens device 1160 around the roll axis.

The control portion 1112 may output action instructions to the driver 1114, the driver 1116, and the driver 1118 according to an action instruction from the control portion 1104 for the universal joint 1110, where the action instructions are used to indicate rotation angles. The driver 1114, the driver 1116, and the driver 1118 drive the driving portion 1124, the driving portion 1126, and the driving portion 1128 according to the action instructions indicating the rotation angles. The rotating mechanism 1134, the rotating mechanism 1136, and the rotating mechanism 1138 are driven and rotated by the driving portion 1124, the driving portion 1126, and the driving portion 1128 respectively, to change postures of the photographing portion 1140 and the lens device 1160.

The photographing portion 1140 may use light passing through the lens system 1168 to perform photographing. The photographing portion 1140 may include a control portion 1222, a photographing element 1221, and a memory 1223. The control portion 1222 may include a microprocessor such as a CPU or an MPU, or a microcontroller such as an MCU. The control portion 1222 performs focus control on the lens system 1168. The control portion 1222 controls the photographing portion 1140 and the lens device 1160 according to action instructions from the control portion 1104 for the photographing portion 1140 and the lens device 1160. The control portion 1222 outputs a control instruction for the lens device 1160 to the lens device 1160 according to a signal received from the controller 50. In addition to an instruction to move a lens group responsible for focusing, the control instruction may further include an instruction to vibrate the lens system 1168, an instruction to detect a temperature of the lens system 1168, or the like.

The memory 1223 may be a computer-readable storage medium, and may include at least one of a SRAM, a DRAM, an EPROM, an EEPROM, or a flash memory such as a USB memory. The memory 1223 may be disposed in a housing of the photographing portion 1140. The photographing portion 1140 may be detachably disposed in the housing.

The photographing element 1221 is held in the housing of the photographing portion 1140, and image data of an optical image is generated by the lens device 1160 and output to the control portion 1222. The photographing element 1221 converts the optical image formed by the lens system 1168 into an electrical signal. For example, the photographing element 1221 may be a charge coupled device (CCD) or a complementary metal oxide semiconductor (CMOS). The photographing element 1221 is arranged in such a way that an image plane of the photographing element 1221 coincides with an image plane of the lens system 1168. An image captured by the lens system 1168 is formed on the image plane of the photographing element 1221 and output from the photographing element 1221 as image data. The control portion 1222 implements signal processing on the image data output from the photographing element 1221 and stores the image data in the memory 1223. Alternatively, the control portion 1222 may output the image data to the memory 1106 through the control portion 1104 for storage.

The lens device 1160 may include a control portion 1162, a memory 1163, a driving mechanism 1161, and the lens system 1168. The lens system in the foregoing implementation may be applied as the lens system 1168.

The control portion 1162 may drive the lens system 1168 according to a control instruction from the control portion 1222. The driving mechanism 1161 may move more than one lens group and the aperture diaphragm in the lens system 1168 in the direction of the optical axis according to a control instruction from the control portion 1162, thereby adjusting a focus of the lens system 1168. The driving mechanism 1161 may control the aperture diaphragm in the lens system 1168 according to a control instruction from the control portion 1162. The driving mechanism 1161 may vibrate the lens system 1168 according to a control instruction from the control portion 1162. The driving mechanism 1161 may include, for example, an actuator. The image formed by the lens system 1168 of the lens device 1160 may be captured by the photographing portion 1140.

The lens device 1160 may be integrally disposed on the photographing portion 1140. The lens device 1160 may be an interchangeable lens. The lens device 1160 may be detachably disposed relative to the photographing portion 1140.

The photographing apparatus 1230 may include a control portion 1232, a control portion 1234, a photographing element 1231, a memory 1233, and a lens 1235. The control portion 1232 may include a microprocessor such as a CPU or an MPU, or a microcontroller such as an MCU. The control portion 1232 controls the photographing element 1231 according to an action instruction from the control portion 1104 for the photographing element 1231.

The control portion 1234 may include a microprocessor such as a CPU or an MPU, or a microcontroller such as an MCU. The control portion 1234 may adjust a focus of the lens 1235 according to an action instruction for the lens 1235. The control portion 1234 may control an aperture diaphragm of the lens 1235 according to an action instruction for the lens 1235.

The memory 1233 may be a computer-readable storage medium. The memory 1233 may include at least one of a SRAM, a DRAM, an EPROM, an EEPROM, or a flash memory such as a USB memory.

The photographing element 1231 generates image data of an optical image formed by the lens 1235, and outputs the image data to the control portion 1232. The control portion 1232 stores the image data output from the photographing element 1231 in the memory 1233.

In this disclosure, the UAV 40 may include the control portion 1104, the control portion 1112, the control portion 1222, the control portion 1232, the control portion 1234, and the control portion 1162. However, the processing performed by a plurality of the control portion 1104, the control portion 1112, the control portion 1222, the control portion 1232, the control portion 1234, and the control portion 1162 may be performed by any control portion. Alternatively, the processing performed by the control portion 1104, the control portion 1112, the control portion 1222, the control portion 1232, the control portion 1234, and the control portion 1162 may be performed by one control portion. In this disclosure, the UAV 40 may include the memory 1106, the memory 1223, and the memory 1233. Information stored in at least one of the memory 1106, the memory 1223, and the memory 1233 may be stored in one or more other memories among the memory 1106, the memory 1223, and the memory 1233.

The photographing apparatus 1220 may include the lens device 1160 having the lens system in the foregoing implementation, so that a miniature photographing function with high optical performance may be provided.

As an example of a system including the lens system in the foregoing implementation, a stabilizer is hereinafter described.

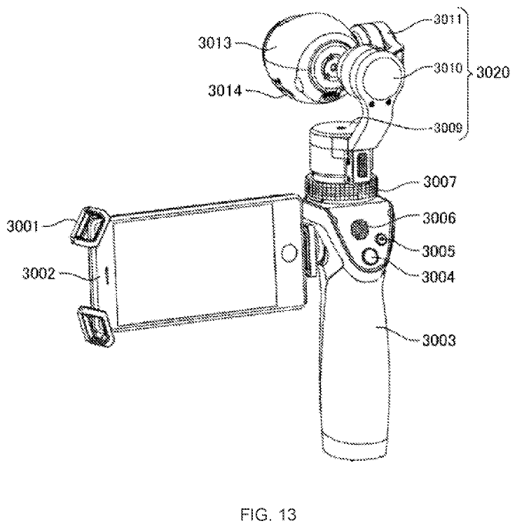

FIG. 13 is an exterior perspective view of an example of a stabilizer 3000. The stabilizer 3000 is an example of a movable object. For example, a camera unit 3013 included in the stabilizer 3000 may have a photographing apparatus having a same configuration as the photographing apparatus 1220. The camera unit 3013 may have a lens device having a same configuration as the lens device 1160.

The stabilizer 3000 may include the camera unit 3013, a universal joint 3020, and a handle 3003. The universal joint 3020 rotatably supports the camera unit 3013. The universal joint 3020 has a translation axis 3009, a roll axis 3010, and a pitch axis 3011. The universal joint 3020 rotatably supports the camera unit 3013 around the translation axis 3009, the roll axis 3010, and the pitch axis 3011. The universal joint 3020 is an example of a supporting mechanism.

The camera unit 3013 is an example of a photographing apparatus. The camera unit 3013 has a slot 3014 into which a memory is inserted. The universal joint 3020 is fixed to the handle 3003 by a support 3007.

The handle 3003 has various buttons for operating the universal joint 3020 and the camera unit 3013. The handle 3003 includes a shutter button 3004, a recording button 3005, and an operation button 3006. Pressing the shutter button 3004 enables the camera unit 3013 to record a still image. Pressing the recording button 3005 enables the camera unit 3013 to record a video.

A device holder 3001 may be fixed to the handle 3003. The device holder 3001 may hold a mobile device 3002 such as a smartphone. The mobile device 3002 may be in communication with the stabilizer 3000 through a wireless network such as Wi-Fi. Therefore, the image captured by the camera unit 3013 may be displayed on a screen of the mobile device 3002.

In the stabilizer 3000, the camera unit 3013 also includes the lens system in the foregoing implementation, so that a miniature photographing function with high optical performance can be provided.

The UAV 40 and the stabilizer 3000 are illustrated above as examples of a movable object. The photographing apparatus having the same configuration as the photographing apparatus 1220 may be mounted on a movable object other than the UAV 40 and the stabilizer 3000.

As for an execution order of each process of actions, sequences, steps, stages, and the like in the apparatus, system, program, and method shown in the claims, specification, and drawings, as long as “earlier than . . . ”, “prior to . . . ”, or the like are not explicitly indicated, or when an output of a previous process is not to be used in a subsequent process, any order may be used for implementation. Regarding operation procedures in the claims, the specification, and the drawings of the specification, for convenience, “first”, “then”, and the like are used for description, but this does not mean that the order must be used for implementation.

### DESCRIPTION OF REFERENCE NUMERALS

10: movable object system
40: UAV
50: controller
52: operation portion
54: display portion
1101: UAV body
1102: interface
1104: control portion
1106: memory
1110: universal joint
1112: control portion
1114, 1116, and 1118: drivers
1124, 1126, and 1128: driving portions
1130: supporting mechanism
1134, 1136, and 1138: rotating mechanisms
1140: photographing portion
1160: lens device
1161: driving mechanism
1162: control portion
1163: memory
1168: lens system
1220 and 1230: photographing apparatuses
1221: photographing element
1222: control portion
1223: memory
1231: photographing element
1232: control portion
1233: memory
1234: control portion
1235: lens
100, 200, 300, 400, and 500: lens systems
110, 210, 310, 410, and 510: first lens groups
120, 220, 320, 420, and 520: second lens groups
130, 230, 330, 430, and 530: third lens groups
3000: stabilizer
3001: device holder
3002: mobile device
3003: handle
3004: shutter button
3005: recording button
3006: operation button
3007: support
3009: translation axis
3010: roll axis
3011: pitch axis
3013: camera unit
3014: slot
3020: universal joint

What is claimed is:

1. A lens system, comprising, sequentially from an object side:
a first lens group having a positive refractive power, including:
a negative meniscus lens that is arranged closest to the object side and includes a convex surface facing the object side, and
a first cemented lens;
an aperture diaphragm next to the first cemented lens;
a second lens group having a positive refractive power, including a second cemented lens arranged next to the aperture diaphragm; and
a third lens group that has a positive refractive power and is movable along a direction of an optical axis as focusing from an object at infinity distance to a closer object, including a single lens, wherein
the following conditions are satisfied:
1.0<L/Y<2.3, and
1<f1/f<3, wherein
L is a distance from a lens surface of the first lens group closest to the object side to a lens surface closest to an image side on the optical axis,
Y is a maximum image height,
f1 is a focal length of the first lens group, and
f is a focal length of the entire lens system.

2. The lens system according to claim 1, wherein the following conditions are satisfied:
−2.0<fL11/f<−0.5; and
0.4<fCL1/f1<2.5, wherein
fL11 is a focal length of the negative meniscus lens, and fCL1 is a focal length of the first cemented lens.

3. The lens system according to claim 1, wherein the following conditions are satisfied:
0<NCL1p−NCL1n<0.3;
3<VCL1p−VCL1n<20; and
−0.07<θCL1p−θCL1n<−0.02, wherein
NCL1p is a refractive index of a positive lens of the first cemented lens to a d-line with a wavelength of 587.6 nm,
NCL1n is a refractive index of a negative lens of the first cemented lens to the d-line,
VCL1p is an Abbe number of the positive lens of the first cemented lens based on the d-line,
VCL1n is an Abbe number of the negative lens of the first cemented lens based on the d-line,
θCL1p is a partial dispersion ratio of the positive lens of the first cemented lens between a g-line with a wavelength of 435.8 nm and an F-line with a wavelength 486.1 nm,
θCL1n is a partial dispersion ratio of the negative lens of the first cemented lens between the g-line and the F-line, and
the d-line, the F-line and the g-line are Fraunhofer lines of an Abbe number that measures light dispersion.

4. The lens system according to claim 1, wherein the following conditions are satisfied:
−0.3<NCL2p−NCL2n<0; and
−0.08<θCL2p−θCL2n<0.04, wherein
NCL2p is a refractive index of a positive lens of the second cemented lens to a d-line having a wavelength of 587.6 nm,
NCL2n is a refractive index of a negative lens of the second cemented lens to the d-line,
θCL2p is a partial dispersion ratio of the positive lens of the second cemented lens between a g-line with a wavelength of 435.8 nm and an F-line with a wavelength 486.1 nm,
θCL2n is a partial dispersion ratio of the negative lens constituting the second cemented lens between the g-line and the F-line, and
the d-line, the F-line and the g-line are Fraunhofer lines of an Abbe number that measures light dispersion.

5. The lens system according to claim 1, wherein the following conditions are satisfied:
VL11>55; and
0.62<θgL11+0.001625×VL11<0.70, wherein
VL11 is an Abbe number of the negative meniscus lens based on a d-line with a wavelength of 587.6 nm,
θgL11 is a partial dispersion ratio of the negative meniscus lens between a g-line with a wavelength of 435.8 nm and an F-line with a wavelength 486.1 nm, and
the d-line, the F-line and the g-line are Fraunhofer lines of an Abbe number that measures light dispersion.

6. The lens system according to claim 1, wherein the following condition is satisfied:
2.0<f3/f<5.5, wherein
f3 is a focal length of the third lens group.

7. The lens system according to claim 1, wherein all lenses are spherical lenses.

8. The lens system according to claim 1, wherein the following condition is satisfied:
−0.25<(Y−f·tan ω)/(f·tan ω)<−0.05, wherein
ω is a maximum half field angle of the lens system.

9. A photographing apparatus, comprising
a photographing element; and
a lens system, including, sequentially from an object side:
a first lens group having a positive refractive power, including:
a negative meniscus lens that is arranged closest to the object side and includes a convex surface facing the object side, and
a first cemented lens;
an aperture diaphragm next to the first cemented lens;
a second lens group having a positive refractive power, including a second cemented lens arranged next to the aperture diaphragm; and
a third lens group that has a positive refractive power and is movable along a direction of an optical axis as focusing from an object at infinity distance to a closer object, including a single lens, wherein
the following conditions are satisfied:
1.0<L/Y<2.3, and
1<f1/f<3, wherein
L is a distance from a lens surface of the first lens group closest to the object side to a lens surface closest to an image side on the optical axis,
Y is a maximum image height,
f1 is a focal length of the first lens group, and
f is a focal length of the entire lens system.

10. The photographing apparatus according to claim 9, wherein the following conditions are satisfied:
−2.0<fL11/f<−0.5; and
0.4<fCL1/f1<2.5, wherein
fL11 is a focal length of the negative meniscus lens, and fCL1 is a focal length of the first cemented lens.

11. The photographing apparatus according to claim 9, wherein the following conditions are satisfied:
0<NCL1p−NCL1n<0.3;
3<VCL1p−VCL1n<20; and
−0.07<θCL1p−θCL1n<−0.02, wherein
NCL1p is a refractive index of a positive lens of the first cemented lens to a d-line with a wavelength of 587.6 nm,
NCL1n is a refractive index of a negative lens of the first cemented lens to the d-line,
VCL1p is an Abbe number of the positive lens of the first cemented lens based on the d-line,
VCL1n is an Abbe number of the negative lens of the first cemented lens based on the d-line,
θCL1p is a partial dispersion ratio of the positive lens of the first cemented lens between a g-line with a wavelength of 435.8 nm and an F-line with a wavelength 486.1 nm,
θCL1n is a partial dispersion ratio of the negative lens of the first cemented lens between the g-line and the F-line, and
the d-line, the F-line and the g-line are Fraunhofer lines of an Abbe number that measures light dispersion.

12. The photographing apparatus according to claim 9, wherein the following conditions are satisfied:
−0.3<NCL2p−NCL2n<0; and
−0.08<θCL2p−θCL2n<0.04, wherein
NCL2p is a refractive index of a positive lens of the second cemented lens to a d-line having a wavelength of 587.6 nm,
NCL2n is a refractive index of a negative lens of the second cemented lens to the d-line,
θCL2p is a partial dispersion ratio of the positive lens of the second cemented lens between a g-line with a wavelength of 435.8 nm and an F-line with a wavelength 486.1 nm,
θCL2n is a partial dispersion ratio of the negative lens constituting the second cemented lens between the g-line and the F-line, and
the d-line, the F-line and the g-line are Fraunhofer lines of an Abbe number that measures light dispersion.

13. The photographing apparatus according to claim 9, wherein the following conditions are satisfied:
VL11>55; and
0.62<θgL11+0.001625×VL11<0.70, wherein
VL11 is an Abbe number of the negative meniscus lens based on a d-line with a wavelength of 587.6 nm,
θgL11 is a partial dispersion ratio of the negative meniscus lens between a g-line with a wavelength of 435.8 nm and an F-line with a wavelength 486.1 nm, and
the d-line, the F-line and the g-line are Fraunhofer lines of an Abbe number that measures light dispersion.

14. The photographing apparatus according to claim 9, wherein the following conditions are satisfied:
2.0<f3/f<5.5, wherein
f3 is a focal length of the third lens group.

15. A movable object, comprising
a lens system, including, sequentially from an object side:
a first lens group having a positive refractive power, including:
a negative meniscus lens that is arranged closest to the object side and includes a convex surface facing the object side, and
a first cemented lens;
an aperture diaphragm next to the first cemented lens;
a second lens group having a positive refractive power, including a second cemented lens arranged next to the aperture diaphragm; and
a third lens group that has a positive refractive power and is movable along a direction of an optical axis as focusing from an object at infinity distance to a closer object, including a single lens, wherein
the following conditions are satisfied:
1.0<L/Y<2.3, and
1<f1/f<3, wherein
L is a distance from a lens surface of the first lens group closest to the object side to a lens surface closest to an image side on the optical axis,
Y is a maximum image height,
f1 is a focal length of the first lens group, and
f is a focal length of the entire lens system.

16. The movable object according to claim 15, wherein the following conditions are satisfied:
−2.0<fL11/f<−0.5; and
0.4<fCL1/f1<2.5, wherein
fL11 is a focal length of the negative meniscus lens, and fCL1 is a focal length of the first cemented lens.

17. The movable object according to claim 15, wherein the following conditions are satisfied:
0<NCL1p−NCL1n<0.3;
3<VCL1p−VCL1n<20; and
−0.07<θCL1p−θCL1n<−0.02, wherein
NCL1p is a refractive index of a positive lens of the first cemented lens to a d-line with a wavelength of 587.6 nm,
NCL1n is a refractive index of a negative lens of the first cemented lens to the d-line,
VCL1p is an Abbe number of the positive lens of the first cemented lens based on the d-line,
VCL1n is an Abbe number of the negative lens of the first cemented lens based on the d-line,
θCL1p is a partial dispersion ratio of the positive lens of the first cemented lens between a g-line with a wavelength of 435.8 nm and an F-line with a wavelength 486.1 nm,
θCL1n is a partial dispersion ratio of the negative lens of the first cemented lens between the g-line and the F-line, and
the d-line, the F-line and the g-line are Fraunhofer lines of an Abbe number that measures light dispersion.

18. The movable object according to claim 15, wherein the following conditions are satisfied:
−0.3<NCL2p−NCL2n<0; and
−0.08<θCL2p−θCL2n<0.04, wherein
NCL2p is a refractive index of a positive lens of the second cemented lens to a d-line having a wavelength of 587.6 nm,
NCL2n is a refractive index of a negative lens of the second cemented lens to the d-line,
θCL2p is a partial dispersion ratio of the positive lens of the second cemented lens between a g-line with a wavelength of 435.8 nm and an F-line with a wavelength 486.1 nm,
θCL2n is a partial dispersion ratio of the negative lens constituting the second cemented lens between the g-line and the F-line, and
the d-line, the F-line and the g-line are Fraunhofer lines of an Abbe number that measures light dispersion.

19. The movable object according to claim 15, wherein the following conditions are satisfied:
VL11>55; and
0.62<θgL11+0.001625×VL11<0.70, wherein
VL11 is an Abbe number of the negative meniscus lens based on a d-line with a wavelength of 587.6 nm,
θgL11 is a partial dispersion ratio of the negative meniscus lens between a g-line with a wavelength of 435.8 nm and an F-line with a wavelength 486.1 nm, and
the d-line, the F-line and the g-line are Fraunhofer lines of an Abbe number that measures light dispersion.

20. The movable object according to claim 15, wherein the movable object is an unmanned aerial vehicle.
